(19) United States
(12) Patent Application Publication
(10) Pub. No.: US 2007/0264431 A1
(43) Pub. Date: Nov. 15, 2007

(54) APPARATUS FOR FILM FORMATION

(75) Inventors: Shih-Ming Wang, Tao-Yuan (TW); Sheng-Yuan Huang, Tao-Yuan (TW); Chia-You Chung, Tao-Yuan (TW)

Correspondence Address: WPAT, PC, 7225 BEVERLY ST., ANNANDALE, VA, 22003, US

(73) Assignee: CHUNG YUAN CHRISTIAN UNIVERSITY, Tao-Yuan (TW)

(21) Appl. No.: 11/457,459

(22) Filed: Jul. 14, 2006

(30) Foreign Application Priority Data
May 11, 2006 (TW) 095116661

(51) Int. Cl. B05D 3/12; B05C 13/00

(52) U.S. Cl. 427/356; 118/56

(57) ABSTRACT

The present invention provides an apparatus for forming a film. The apparatus comprises a fluid auto-injecting mechanism, a tension control mechanism, and a scraper with a height. The fluid auto-injecting mechanism injects a viscous fluid material on a substrate and controls the injection quantity of the fluid material wherein the fluid material is capable of filtering out volatile organic compounds and the substrate has a shape and experiences a tension. The tension control mechanism controls the tension of the substrate to prevent from shape deformation. The scraper uniformly scraps the fluid material wherein the height of the scraper is adjustable.

### BACKGROUND OF THE INVENTION

1. Field of the Invention

The present invention is generally related to an apparatus for film formation, and more particularly to a method for film formation.

2. Description of the Prior Art

In the past decades, petroleum related industrial processes, such as oil refinery, painting, solvent extraction, etc., had been rapidly developed to accomplish economic growth in countries like Taiwan. However, these processes produce VOC (volatile organic compound) exhaust gases. Especially, the market for oil products is opened in Taiwan so that the number of gas stations significantly increases. There are 30,000 tons of VOCs dissipated from gas stations, that is 6% of the total discharge amount per year. If these are discharged to air directly, they not only pollute the environment but also affect the health of animals and plants on the earth. Furthermore, natural resources are also wasted. The developed module is mainly applied in the recycle process of oil gas. But, there are a wide variety of volatile organic compounds (VOCs) as well as many operation environments producing VOCs. A system designed for different operation environments and suitable substances for preparing film module can be applied in the related treatment processes.

Recycling VOCs by a film process has not been utilized in Taiwan. Distillation and burning are still common ways for recycling waste solvents. Besides, there is no self-developed system to recycle VOCs locally. Although there are imported equipments to recycle VOCs in oil gas, the cost of equipment is expensive and maintenance technology is relied on the overseas company. It is difficult to be self-reliant. The technology of this type has been available in countries, such as Germany and Singapore. Sulzer Chemtech Co. in Singapore has a simple processing system and also tries to extend to the applications in different solvent systems recently. Vacono in Germany also has a VOC recycling equipment by the film system and has mature technology but the cost of the equipment is very expensive.

By the refrigeration and air-conditioning technique and the film separation process, VOCs in oil gas can be recycled effectively. Research in film formation and module has initial fruitful results. The separation of VOCs depends on the interaction of the chemical bonding and the physical property between VOC molecules and film. The processing quantity of medium to large size films meets the economic needs. However, the module for processing VOCs cannot be obtained individually and only be sold together with the whole equipment. There is neither VOC module in Taiwan for sale nor equipment for producing medium to large size films. Thus, automatically producing medium to large size films becomes an important key to commercialize a VOC module. Therefore, the present invention is to research an apparatus for medium to large size film formation to massively produce films with filtering functionality in the VOC module. Initial applications are in the recycle process of VOCs in oil gas. Systems for various operation environments and suitable substances for preparing film module can be applied in the related treatment processes.

Due to many petroleum industrial manufactures in Taiwan, it is a serious problem that VOC exhaust gas from these manufactures pollutes environment. Thus, it is very important to recycle oil gas with various compositions. By medium to large size film with filter functionality, these VOCs in oil gas are recycled to thereby be fully utilized.

To solve the above-mentioned prior art, a new apparatus for recycling VOCs is still needed corresponding to both economic effect and utilization in industry.

### SUMMARY OF THE INVENTION

In light of the above-mentioned prior art, the present invention provides an apparatus for film formation, comprising: a substrate auto-feeding system for automatically changing the substrate wherein the substrate has a shape and a tension; a fluid auto-injecting mechanism for injecting a viscous fluid material on a substrate and controlling the fluid material wherein the fluid material is capable of filtering out volatile organic compounds and the substrate has a shape and a tension; a tension control mechanism for controlling the tension of the substrate to prevent from shape deformation; a scraper with a height for uniformly scraping the fluid material wherein the height of the scraper is adjustable; an oven for heating said fluid material; and, a material removing module for removing the part of the substrate that is not coated with the fluid material.

The apparatus for film formation further comprises two linear slide rails for mounting the scraper. The material of the scraper is capable of preventing the substrate from being scratched. A preferred example is an elastic rubber scraping board.

Because the height of the scraper, the flow rate of the fluid material and uniformity are closely related to the thickness of the film and the quality of the film, they can be accomplished by a precise micro-adjustable scraping mechanism and a fluid material module that can control the flow rate of the fluid material.

### BRIEF DESCRIPTION OF THE DRAWINGS

FIG. 1 is a schematic diagram illustrating the automatic apparatus for film formation according to the second embodiment of the present invention;

FIG. 2 is a schematic diagram illustrating a substrate auto-feeding system for large substrate size according to the second embodiment of the present invention;

FIG. 3 is a functional schematic diagram illustrating a circular slide unit with pin holes on the circular axle 18 for fastening the crank 16 in the case of smaller working width;

FIG. 4 is a schematic diagram illustrating a tension control mechanism according to the second embodiment of the present invention;

FIG. 5 is a schematic diagram illustrating a pretension roller according to the second embodiment of the present invention;

FIG. 6 is a schematic diagram illustrating a fluid auto-injecting mechanism according to the second embodiment of the present invention;

FIG. 7 is a schematic diagram illustrating a knob switch according to the second embodiment of the present invention;

FIG. 8 is a schematic diagram illustrating a fluid outlet according to the second embodiment of the present invention;

FIG. 9 is a schematic diagram illustrating a small storage chamber on the upper part of the mechanism according to the second embodiment of the present invention;

FIG. 10 is a schematic diagram illustrating a removable roller module according to the second embodiment of the present invention;

FIG. 11 is a schematic diagram illustrating a roller in the scraping film area according to the second embodiment of the present invention;

FIG. 12 is a schematic diagram illustrating a scraper micro-adjustment mechanism according to the second embodiment of the present invention;

FIG. 13 is a schematic diagram illustrating a film formation baking apparatus according to the second embodiment of the present invention;

FIG. 14 is a schematic diagram illustrating a circular-blade-type auto-trimming mechanism according to the second embodiment of the present invention;

FIG. 15 is a schematic diagram illustrating a setup of trimming substrate according to the second embodiment of the present invention;

FIG. 16 is a schematic diagram illustrating a replaceable roller mechanism;

FIG. 17 is a schematic diagram illustrating a movable sleeve according to the second embodiment of the present invention;

FIG. 18 is a schematic diagram illustrating a removable sleeve according to the second embodiment of the present invention;

FIG. 19 is a schematic diagram illustrating a base for lowering bending stress according to the second embodiment of the present invention;

FIG. 20 is a schematic diagram illustrating a removed material recycle box according to the second embodiment of the present invention;

FIG. 21 is a schematic diagram illustrating a larger size winding module according to the second embodiment of the present invention;

FIG. 22 is a schematic diagram illustrating a smaller size winding module according to the second embodiment of the present invention;

FIG. 23 is a schematic diagram illustrating a side view of a computer simulated mechanism assembly according to the second embodiment of the present invention;

FIG. 24A is a three-dimensional schematic diagram illustrating a computer simulated mechanism assembly according to the second embodiment of the present invention;

FIG. 24B is a schematic diagram illustrating a flow chart for film formation according to the second embodiment of the present invention;

FIG. 25 is a schematic diagram illustrating a linear slide rail according to the second embodiment of the present invention;

FIG. 26 is a schematic diagram illustrating an aluminum flexible coupling according to the second embodiment of the present invention;

FIG. 27 is a schematic diagram illustrating an aluminum flexible coupling according to the second embodiment of the present invention;

FIG. 28 is a schematic diagram illustrating a ball bearing according to the second embodiment of the present invention;

FIG. 29A is a schematic diagram illustrating a control flow chart according to the second embodiment of the present invention;

FIG. 29B is a schematic diagram illustrating computer programming instructions according to the second embodiment of the present invention;

FIG. 29C is a schematic diagram illustrating a XPC computer according to the second embodiment of the present invention;

FIG. 30 is a schematic diagram illustrating a 726 D/A interface card according to the second embodiment of the present invention;

FIG. 31 is a schematic diagram illustrating a motor actuator according to the second embodiment of the present invention;

FIG. 32 is a schematic diagram illustrating an AC servo motor according to the second embodiment of the present invention; and,

FIG. 33 is a schematic diagram illustrating an experimental model according to the second embodiment of the present invention.

### DESCRIPTION OF THE PREFERRED EMBODIMENTS

What is probed into the invention is an apparatus for film formation. Detail descriptions of the structure and elements will be provided in the following in order to make the invention thoroughly understood. Obviously, the application of the invention is not confined to specific details familiar to those who are skilled in the art. On the other hand, the common structures and elements that are known to everyone are not described in details to avoid unnecessary limits of the invention. Some preferred embodiments of the present invention will now be described in greater detail in the following. However, it should be recognized that the present invention can be practiced in a wide range of other embodiments besides those explicitly described, that is, this invention can also be applied extensively to other embodiments, and the scope of the present invention is expressly not limited except as specified in the accompanying claims.

In a first embodiment of the present invention, a method for film formation is provided. In order to have a VOC recycle module for different sizes, a continuous automatic film forming apparatus for medium to large size films is provided according to the present invention for multiple functionalities comprising feeding substrates with different sizes, scraping film, baking, removing materials, forming film, and winding film.

The above-described apparatus is required to uniformly coat a fluid material, capable of filtering out VOCs, on a substrate so as to be applied in a VOC recycle module. In addition, the thickness of the film formed by the fluid material affects effectiveness of recycling VOCs and thus the precision of the thickness needs to be less than 25 μm.

According to the first embodiment, at first a viscous fluid material is slowing dropped on a substrate. Following that, a micro-adjustable scraper is used to scrape the fluid material to let the fluid material uniformly distributed on the substrate. Because the height of the scraper, the flow rate of the fluid material and uniformity are closely related to the thickness of the film and the quality of film, they can be accomplished by a precise micro-adjustable scraping mechanism and a fluid material module that can control the flow rate of the fluid material.

Besides, due to low tension-resistance of the substrate, uniformly scraping the substrate becomes an important operation in the invention. A larger torque is generated while starting a motor. The torque will damage the substrate due to excess tension. Therefore, the tension of the substrate needs to be controlled while operation to prevent deformation of the substrate so as to achieve the operation precision and the quality of the scraped film through a series of tension control mechanisms.

In a second embodiment of the present invention, an apparatus is provided comprising a precise micro-adjustable scraping mechanism, a fluid auto-injecting mechanism, a tension control mechanism, a roller for maintaining film uniformity, a servo control system, a data base for optimizing winding speed control, a scraping area roller module, a circular blade type auto-trimming mechanism, a film auto-feeding and auto-winding mechanism, a film size adjustable mechanism to accomplish the functionalities of controlling film forming precision, controlling the flow rate of a fluid material, preventing starting torque of the apparatus from excessively large, controlling winding film uniformity, controlling the tension of film, controlling winding speed, maintaining cleanliness of the roller in the scraping area, automatically trimming, auto-production and flexibility of manufacturing size.

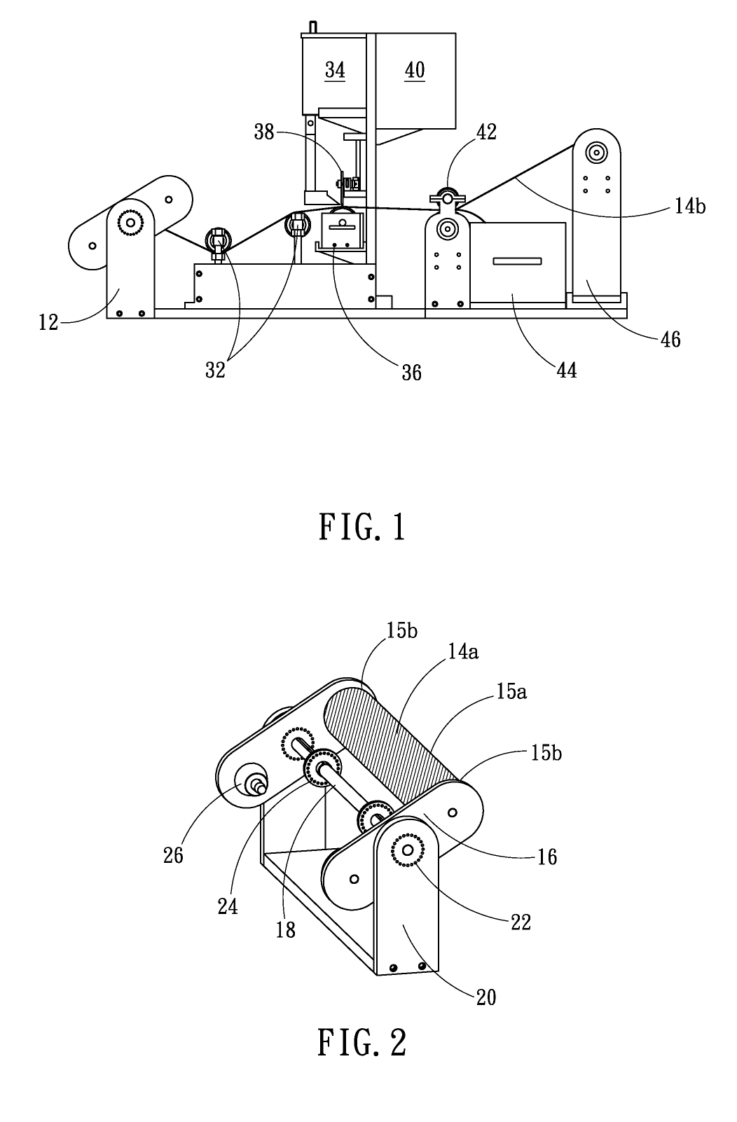

According to the above-described conditions, according to the difficulties and by the design on the mechanisms, the film forming requirements can be accomplished. The designed modules and analysis are shown in the following. FIG. 1 is a schematic diagram illustrating the apparatus for automatic film formation according to the second embodiment of the present invention.

TABLE 1
function analysis of the mechanisms and modules

| Item | Function |
|---|---|
| Substrate auto-feeding system 12 | Adjusting width according to the |
| | working size of a substrate |
| Tension control mechanism 32 | Preventing the torque while |
| | starting a motor from pulling the |
| | substrate so as to assure the |
| | uniformity of the substrate in the |
| | scraping area |
| Fluid auto-injecting mechanism 34 | Controlling the fluid material flow |
| | at the outlet to assure the quality of |
| | film |
| Scraping area roller module 36 | Letting the substrate have a |
| | outward component force for |
| | scraping film uniformly |
| Precise micro-adjustable scraper | Adjusting film thickness by |
| adjusting mechanism 38 | adjusting the height of a scraper |
| Film baking equipment 40 | Speeding up film forming of the |
| | fluid material on the substrate after |
| | the scraping operation |
| circular blade type auto-trimming | Trimming the unnecessary part of |
| mechanism 42 | the substrate on the two sides |
| | before winding |
| Material recycle box 44 | Recycling the substrate cut by the |
| | circular blade |
| film auto-feeding and auto-winding | Adjusting width and winding |
| mechanism 46 | according to the size of the |
| | substrate |

The apparatus for automatic film formation comprises a substrate auto-feeding system 12 for increasing production speed and forming film by using a substrate 14 with different size so as to automatically feed the substrate 14a in FIG. 2. The substrate has a shape 15a, two sides 15b, and a tension.

The substrate auto-feeding system 12 has a prepared set for feeding while a working set is in operation. While replacing the substrate 14a, feeding operation can be continued by turning a crank 16 into a direction so that the timing for replacing the substrate 14a is reduced.

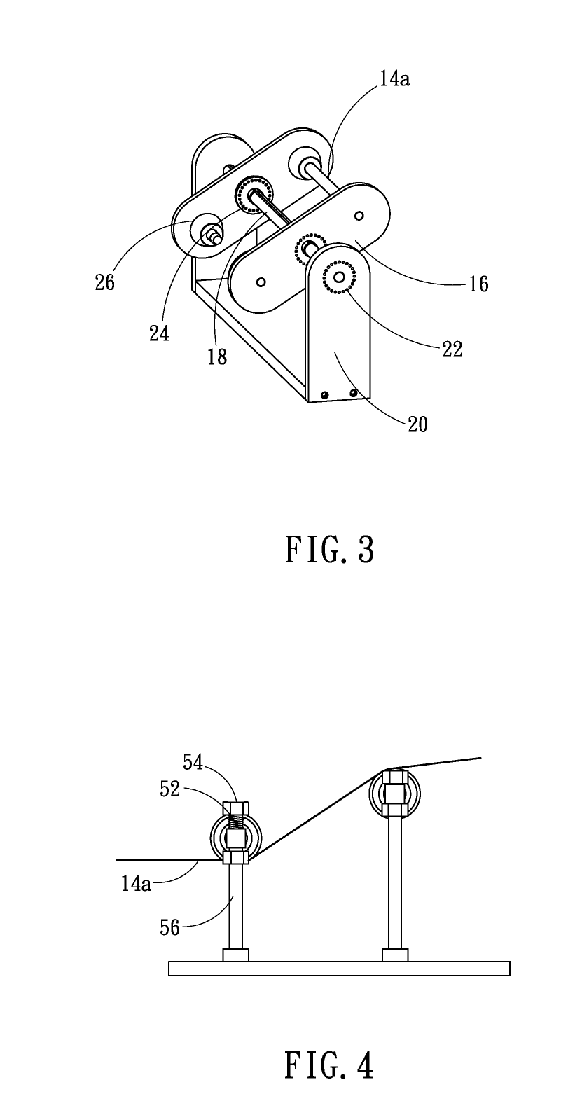

FIG. 2 is a schematic diagram illustrating a substrate auto-feeding system for large substrate size according to the second embodiment of the present invention. As shown in FIG. 2, the setup width of the crank 16 is adjusted according to the width of the substrate 14a. Along a circular axle 18 that is connected to the crank 16, the crank 16 is adjusted to either the left or the right. After adjusting the width, pin holes 22 between the crank 16 and a bearing block 20 are used to adjust a tilting angle to prevent the crank 16 from rotating or jumping. A circular slide unit 24 on the circular axle 18 is provided with pin holes to for fastening the crank 16 in the case of smaller working width, shown in FIG. 3. The substrate auto-feeding system further comprises a cork 26, as shown in FIG. 2.

Due to low tension-resistance of the substrate used in scraping film, the substrate is apt to elastic deformation to change the shape 15a of the substrate 14a. Once the tension is too large for the substrate 14a, the substrate 14a can be damaged or broken easily.

FIG. 4 is a schematic diagram illustrating a tension control mechanism according to the second embodiment of the present invention. As shown in FIG. 4, in order to prevent an inertia torque from generating a tension to the substrate while starting a motor or increasing the speed of the motor, the substrate 14a is tilt to an angle to have an upward component force F while starting the motor.

Therefore, a spring 52 is provided on the upper part of the roller to generate a space for pushing the roller up, shown in FIG. 4. The spring 52 absorbs the excess amount of the torque resulting from starting the motor to diminish the tension while starting the motor. The tension control mechanism further comprises a nut 54 and a bolt 56.

Because the uniformity of the substrate affects the quality of film, the fluid coated on the substrate is distributed unevenly if the substrate is folded or uneven while carrying out scraping film process to thereby affect precision and quality of film.

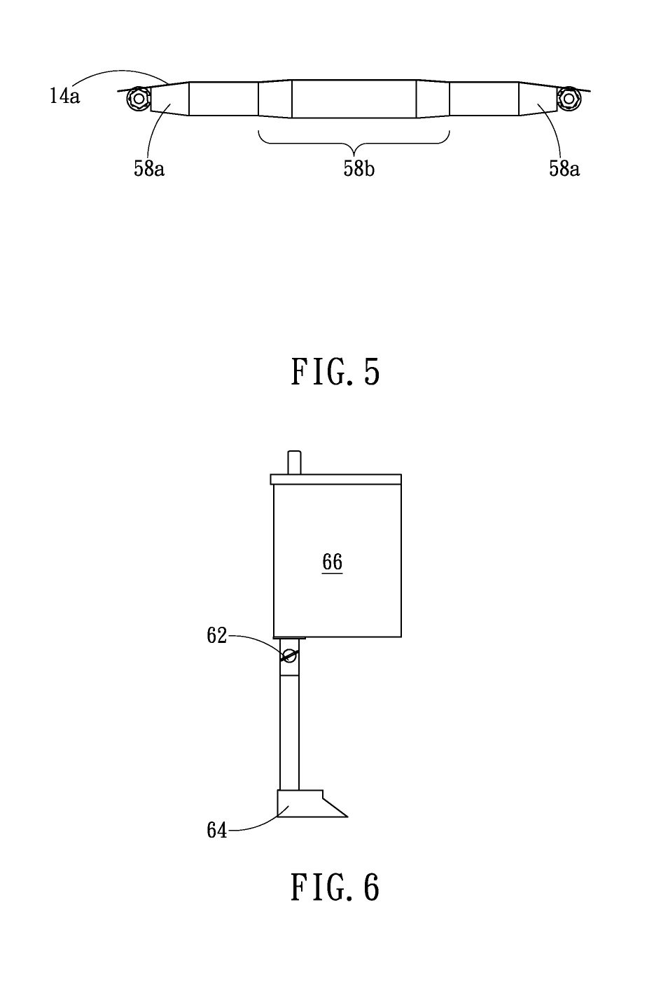

Therefore, before the substrate 14a enters the scraping area, shown in FIG. 5, it is maintained uniform by the roller to enter the scraping area. FIG. 5 is a schematic diagram illustrating a pretension roller according to the second embodiment of the present invention. Because of the design of tilting towards outer peripheral on the two sides of the roller, the running substrate experiences an outward component force. The pretension roller is used to maintain the uniformity of the substrate. As shown in FIG. 5, the two sides 58a and the middle section 58b of the roller is designed to be slightly tilt in which the middle section 58b is extruded more than the sides 58a.

The fluid injecting quantity affects quality and thickness of the film so that the fluid injecting quantity needs to be controlled precisely. Therefore, a fluid auto-injecting mechanism is designed, shown in FIG. 6. FIG. 6 is a schematic diagram illustrating a fluid auto-injecting mechanism according to the second embodiment of the present invention.

The fluid injecting system comprises two parts to control the flow quantity of the fluid, a knob switch 62 and a fluid outlet 64. The knob switch 62 controls supplying and stopping the fluid material. The quantity of the supplied fluid is determined by the tilting angle of the knob switch and adjusted according to the speed of film formation and the thickness of the film. The fluid outlet 64 controls the flow quantity of the fluid more precisely to affect the quality and the thickness of the film. The flow is controlled by adjusting a gap between the fluid outlet and the fluid supply opening. While closing, a temporary fluid storage chamber is provided to store the fluid overflowing from the fluid supply opening.

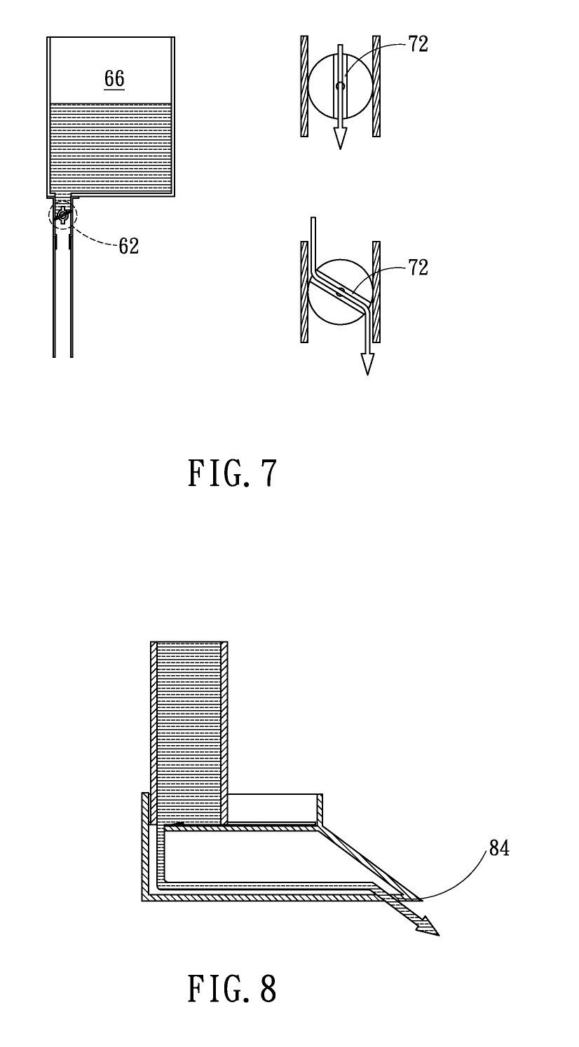

The injecting material opening in the scraping area is designed to be a knob switch 62 to control the fluid flow. FIG. 7 is a schematic diagram illustrating a knob switch according to the second embodiment of the present invention. The knob switch 62 rotates a plate 72. While the plate 72 is in a horizontal position, the fluid supply is stopped. If the plate is turned to an angle, a gap is thereby appeared. By adjusting the tilting angle of the knob switch, the flow quantity is controlled. Considering the fluid flow quantity will affect the quality and the precision of scraping film, while one scraping operation (a set of substrate) is complete, the fluid has to be stopped to avoid polluting the apparatus by turning the knob switch 62 to the horizontal position to stop the fluid flowing towards the scraper and to stop the scraping operation.

In addition to the knob switch 62, a precise control for the fluid is provided at the fluid outlet 64, shown in FIG. 8. FIG. 8 is a schematic diagram illustrating a fluid outlet according to the second embodiment of the present invention. By moving the fluid exit chamber 84 to left or right, the fluid flow starts or stops. The fluid exit chamber 84 is moved to left for supplying the fluid while it is moved to right for stopping the fluid supply, as shown in FIG. 9. Referring to FIG. 9, in order to prevent the fluid from overflowing while stopping the fluid supply, a small storage chamber 92 is provided on the upper part of the mechanism for storing the overflow fluid.

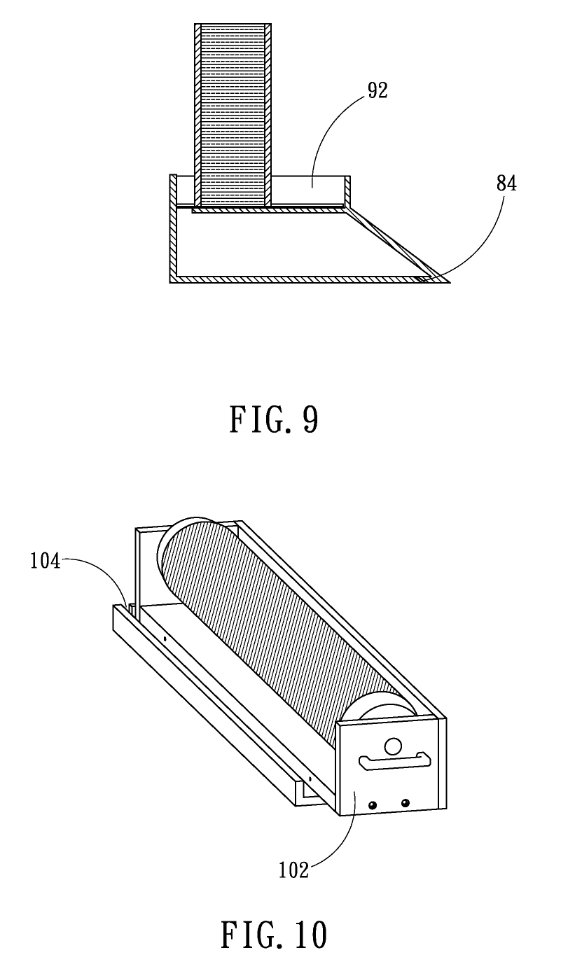

FIG. 10 is a schematic diagram illustrating a removable roller module according to the second embodiment of the present invention. As shown in FIG. 10, the scraping area roller is in a module. An exchangeable roller drawer 102 is used according to the width of the substrate. In the scraping operation, the fluid pollutes the roller more or less. In order to promote the quality of the product, the roller is in a module and can be disassembled to be cleaned. There is a gap 104 between the two sides and the base of the module. By inserting an oblique cone on the left side of the gap 104 while placing the drawer 102 inside, the drawer 102 can be easily pushed to right to achieve the purpose of positioning the roller.

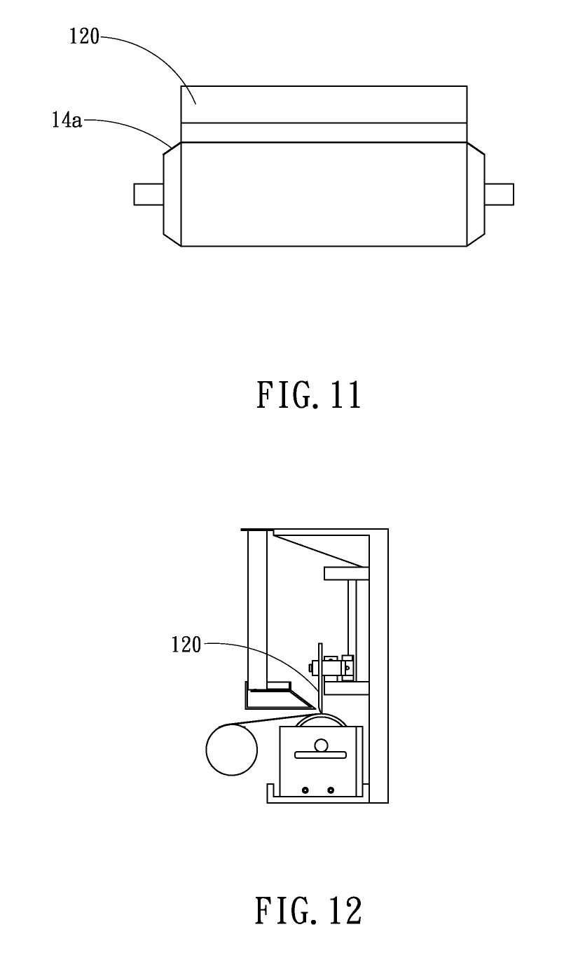

The uniformity of the substrate in the scraping area while scraping is a very important factor to the quality of the product. If the substrate is uneven, the fluid material is not coated uniformly or some part of the substrate is not coated with the fluid material. Therefore, in order maintain the uniformity of the substrate in the scraping area, the roller in the scraping area is designed to let the substrate have a pretension to maintain uniform naturally while scraping. FIG. 11 is a schematic diagram illustrating a roller in the scraping film area according to the second embodiment of the present invention.

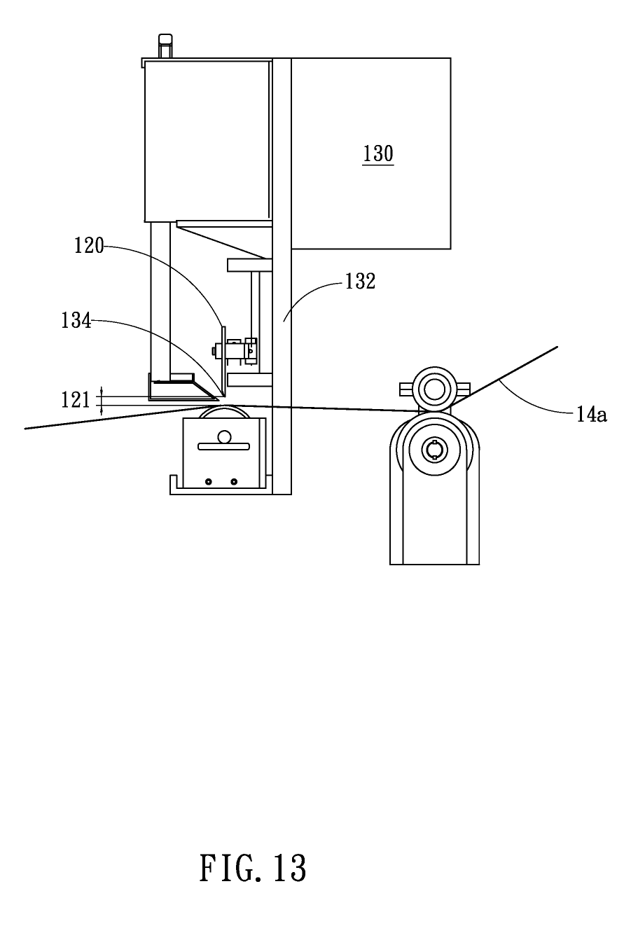

The thickness of the film formed by the fluid material affects efficiency of recycling VOCs and thus the precision of the thickness needs to be less than 25 μm to have better VOC recycle efficiency. The thickness depends on the distance between the scraper and the roller. Thus, a micro-adjustment mechanism is designed to adjust the height 121, shown in FIG. 13, of the scraper. Besides, the lower edge of the scraper has to be parallel to the surface of the roller. If not, the film becomes uneven. The quality and efficiency will be affected. By the above implementation, the thickness of the fluid material is thereby controlled.

FIG. 12 is a schematic diagram illustrating a scraper micro-adjustment mechanism according to the second embodiment of the present invention. As shown in FIG. 12, a scraper 120 is mounted on two linear slide rails 122, parallel to each other. At first, the scraper 120 is fastened on a slide unit 123 of the linear slide rails 122 and thereby the height 121 of the scraper 120, shown in FIG. 13, can be adjusted. The scraper 120 is also designed to be an elastic rubber scraper to prevent the substrate from being scratched and also designed to be exchangeable for the conveniences in cleaning and replacing.

FIG. 13 is a schematic diagram illustrating a film formation baking apparatus according to the second embodiment of the present invention. The film formation baking apparatus is provided to speed up the film formation on the substrate 14a after the scraping process. From our experimental result, the fluid material is apt to be formed by heat. After the scraping process is complete, an oven 130 is provided to let the fluid material on the substrate 14a quickly formed before the winding operation. The height and width of the apparatus is designed to be in accord with the oven 130. An insulation plate 132 is provided between the scraping area 134 and the oven 130 to prevent the scraping area 134 from being affected by the heat from the oven 130.

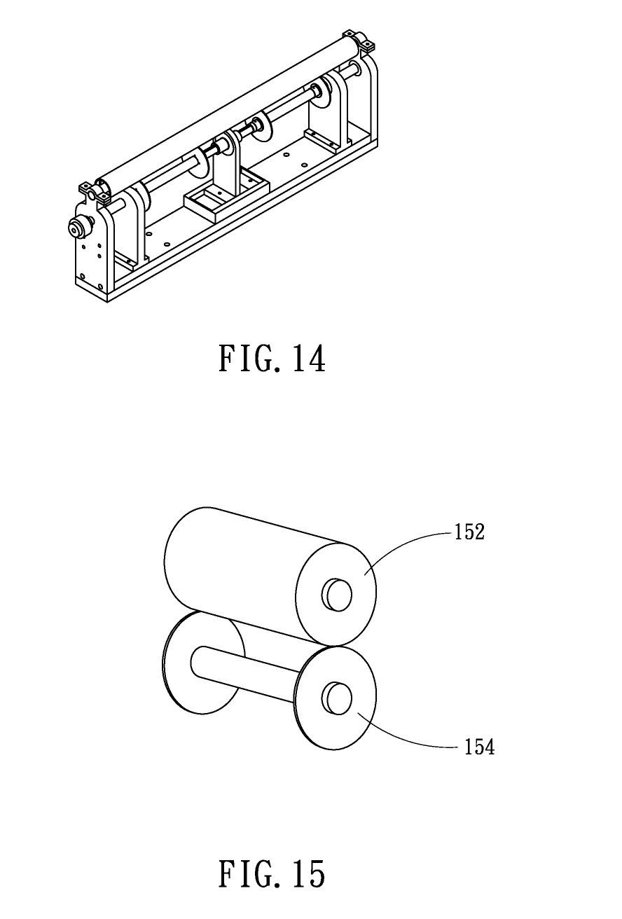

FIG. 14 is a schematic diagram illustrating a circular-blade-type auto-trimming mechanism according to the second embodiment of the present invention. As shown in FIG. 14, after the scraping operation, some portion of the substrate on the two sides 15b, shown in FIG. 2 is not coated with the fluid material. Thus, the unnecessary part of the substrate on the two sides 15b has to be trimmed before winding the substrate. Thus, a circular-blade-type trimming module is provided and a recycle box is also provided underneath the trimming module to recycle the removed substrate.

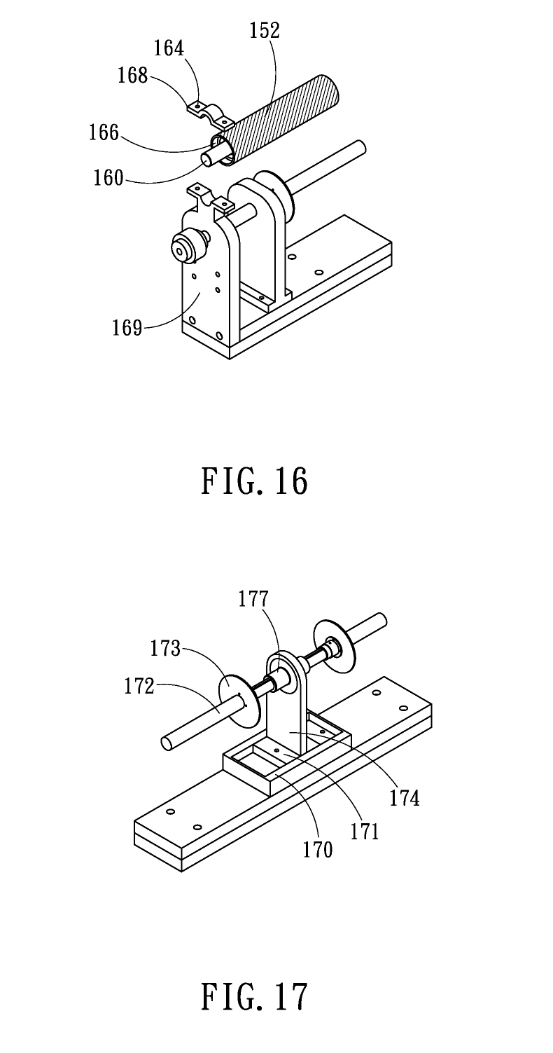

FIG. 15 is a schematic diagram illustrating a setup for trimming substrate according to the second embodiment of the present invention. In the material removing module, the baked film passes underneath the roller 152 and the portion on the two sides 15b is removed by contacting circular blades 154 with a roller 152, according to the width of the film. The roller 152 is replaceable to avoid being damaged by contacted with the circular blade 154 and also for convenience in cleaning and replacing. The roller 152 rotates along with the roller axle through a bearing 166, shown in FIG. 16, to reduce the frictional force between the substrate and the roller 152. The roller 152 has to be balanced as the original balance level after replaced to assure the contact between the roller 152 and the circular blade 154 to achieve the purpose of removing material. The roller axle 160 supporting the roller 152 has to be in tight fit with the bearing block 169. The fitted circular hole is divided into two parts, a lower part and an upper part. The lower part comprises the bearing block 169. The upper part comprises an upper lid 168 to fasten the roller axle 160. Positioning dowels are used to link the lower part and upper part together. By fastening nuts, the two halves snap the roller axle 160 to be in tight contact. FIG. 16 is a schematic diagram illustrating a replaceable roller mechanism. The roller 152 is selected to be a hollow round tube to prevent the roller from being too heavy to generate bending moment. The replaceable roller mechanism further comprises pin holes 164.

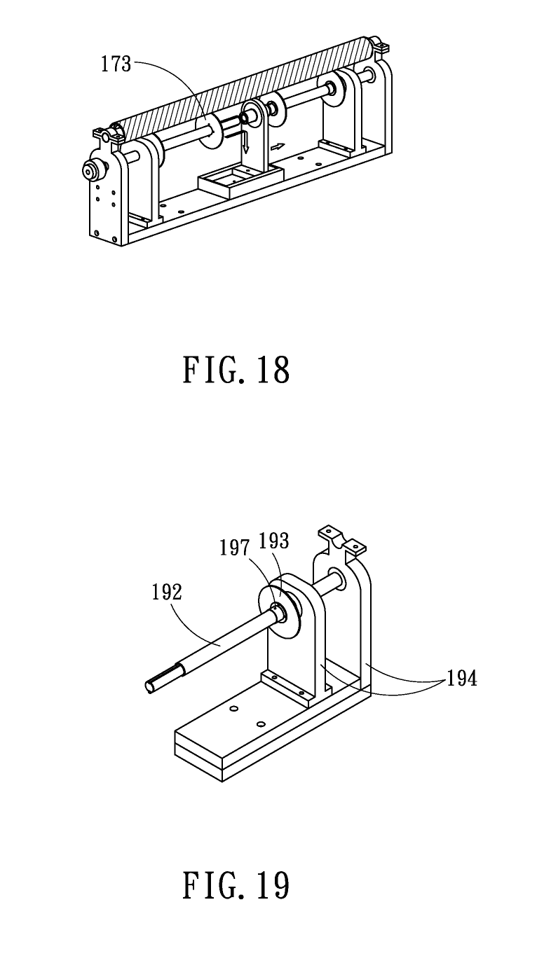

As shown in FIG. 17, a circular blade 173 is replaceable because the circular blade 173 will be worn out after a period of time in use. The transmission axle 172 for the circular blade 173 is divided to two sections and a sleeve 177 is used to transmit power between two sections of the transmission axle 172. The sleeve 177 is mounted on a bearing block 174 with a slide unit type. The slide unit 171 on a slide rail 170 can be moved to left or right. FIG. 17 is a schematic diagram illustrating a movable sleeve according to the second embodiment of the present invention. By moving the sleeve 177 to left to the shoulder of the transmission axle 172, the circular blade 173 on the right hand side can be replaced. The circular blade 173 on the left hand side can be replaced in the same manner, as shown in FIG. 18.

FIG. 19 is a schematic diagram illustrating a base for lowering bending stress according to the second embodiment of the present invention. As shown in FIG. 19, the transmission axle 192 is like a cantilever beam and has a bending moment to result in deflection. Two supporting members in the bearing block 194 are used to support the transmission axle 192 to reduce deflection. On end of the transmission axle 192 extends outside the apparatus in order to be linked with a motor through a coupling for inputting power. A circular blade 193 is mounted on a casing 197 and the casing 197 is mounted on the transmission axle 192.

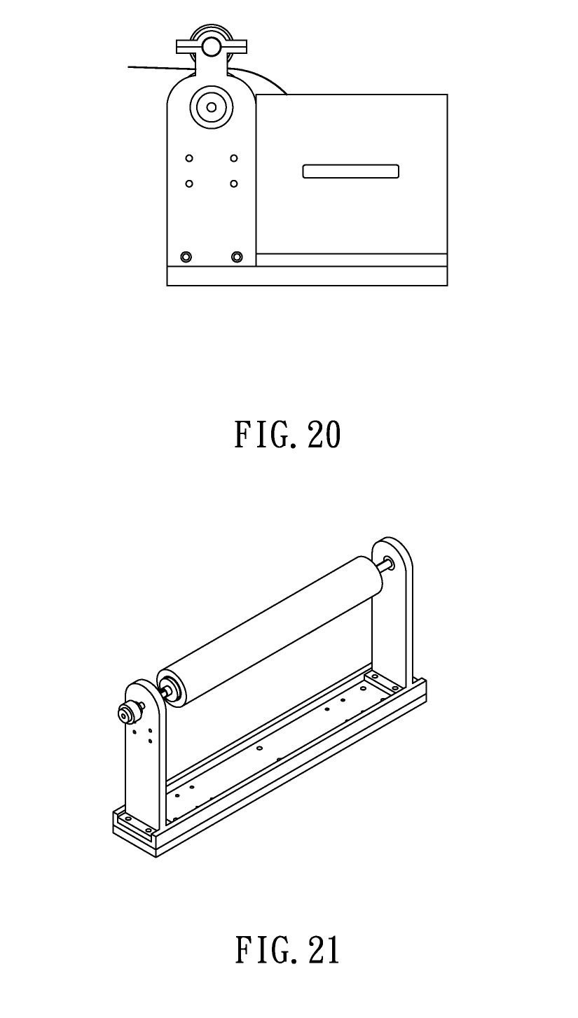

FIG. 20 is a schematic diagram illustrating a removed material recycle box according to the second embodiment of the present invention. As shown in FIG. 20, the removed material recycle box is used to recycle the material from trimming the substrate by the circular blade and designed to be a removable drawer for easy cleanliness.

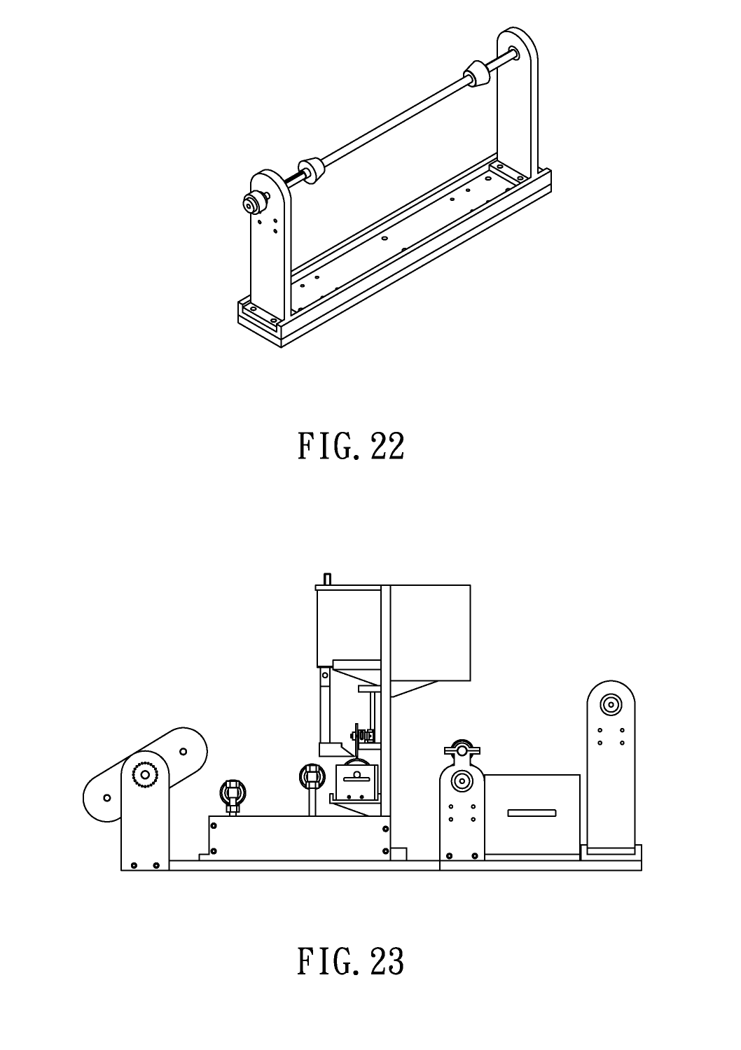

The substrate after film formation is winded on a cylinder for storage and unloading. Power for the cylinder through a motor is needed to carry out the winding operation. The width of the cylinder depends on the size of the substrate. The width of the base for the cylinder has to be adjusted for the cylinder with different size. As shown in FIGS. 21 and 22, similar to the substrate auto-feeding module, the cylinder is mounted on a base, whose width is adjustable, and two corks are provided on the left-hand and right-hand sides to mount the cylinder. FIG. 21 is a schematic diagram illustrating a larger size winding module according to the second embodiment of the present invention. FIG. 22 is a schematic diagram illustrating a smaller size winding module according to the second embodiment of the present invention. As shown in FIGS. 21 and 22, according to the processing size, its axle is connected to a motor through a coupling for the winding operation.

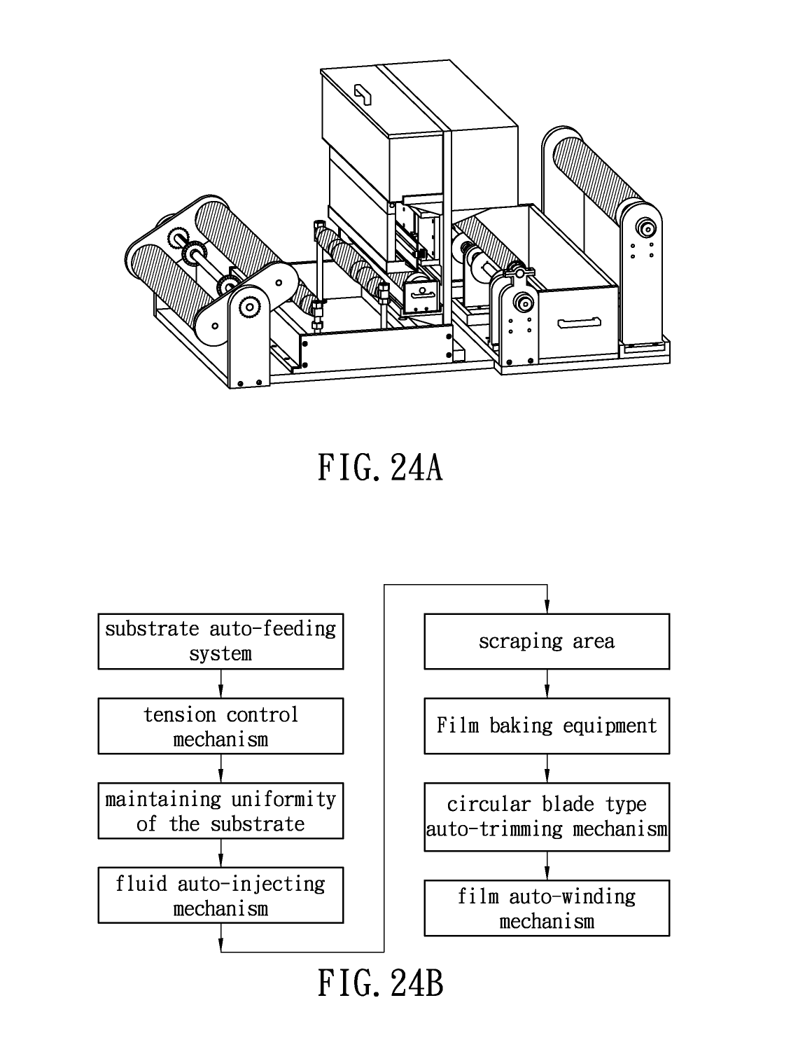

FIG. 23 is a schematic diagram illustrating a side view of a computer simulated mechanism assembly according to the second embodiment of the present invention. FIG. 24A is a three-dimensional schematic diagram illustrating a computer simulated mechanism assembly according to the second embodiment of the present invention. FIG. 24B is a schematic diagram illustrating a flow chart for film formation according to the second embodiment of the present invention.

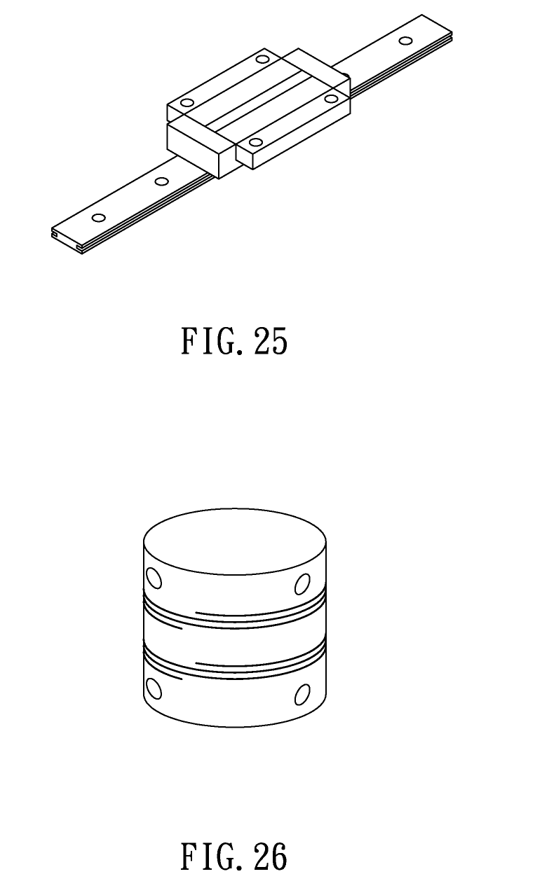

The selection of the mechanical components is shown in FIG. 25. A linear slide rail is selected because of the following merits:

1. frictional force is smaller because the motion of the linear slide rail belongs to dynamic friction, the minimum movable unit is accurate, and power consumption is low;
2. the material of the linear slide rail is suitable for heat treatment and has long lifetime;
3. heat deformation is small, precision is stable, and good mechanical properties; and,
4. easy to assembly, exchangeability, and expandability.

The selection of the size and type of key is according to the following principles: (the design of axle includes the size of the keyseat and the real axial diameter at the keyseat)

1. determining to use either a squared key or rectangular key;
2. assigning the material of the key, such as AISI 1020 carbon steel;
3. determining the yield strengths of the material of the key, axle, and hub;
4. calculating the minimal required length of the key durable for shear stress and bearing stress;
5. assigning the real length to be larger than the calculated minimal length;
6. determining the standard deviation of the size of the key and keyseat according to ASME B17.1 standard.

The following important points should be noted while selecting the coupling:

1. the coupling should be in a tight fit with the transmission axle and the motor output axle;
2. light weight;
3. durable for loading force from the motor;
4. coupling with lower cost is preferred; and,
5. the key of the motor should be matched with the keyseat of the coupling.

FIG. 26 is a schematic diagram illustrating an aluminum flexible coupling according to the second embodiment of the present invention.

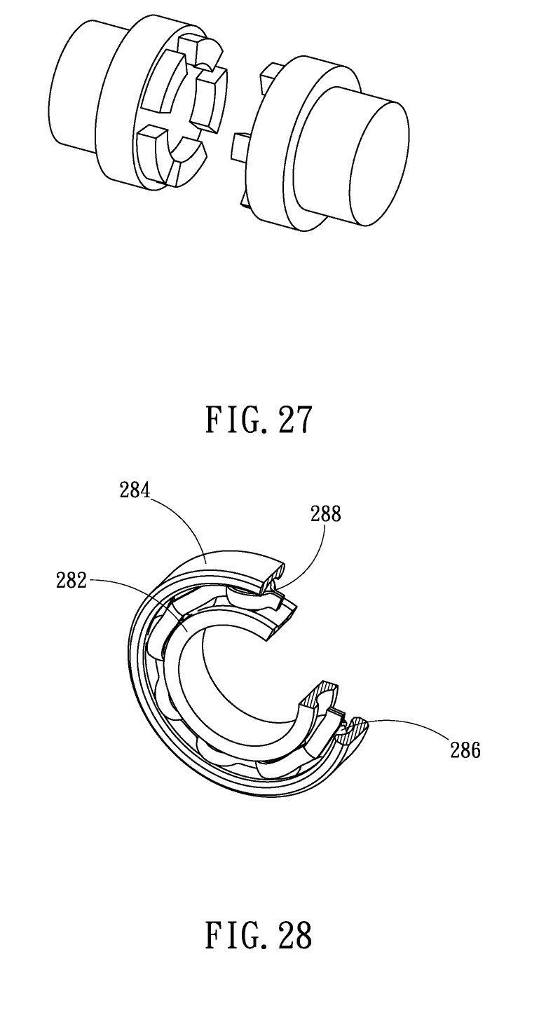

FIG. 27 is a schematic diagram illustrating an aluminum flexible coupling according to the second embodiment of the present invention.

FIG. 28 is a schematic diagram illustrating a ball bearing according to the second embodiment of the present invention. As shown in FIG. 28, the ball bearing is durable for radial load, thrust load or the both. There are four major members: inner race 282, outer race 284, ball 288, and retainer (or separator) 286.

The following factors should be considered while selecting the bearing:

1. determining the designed load of the bearing;
2. determining the minimal required axial diameter that limits the diameter of the bearing;
3. choosing the bearing type;
4. determining the designed lifetime of the bearing;
5. determining the lifetime factor of the speed;
6. calculating the basic dynamic rated load;
7. finding a set of bearings matching with the basic dynamic rated load;
8. choosing the convenient shape for the bearing; and,
9. determining the conditions for assembly.

Table 2 shows the comparison between bearings according to the second embodiment of the present invention.

TABLE 2
comparison between bearings

| | | | Capability for |
|---|---|---|---|
| | Capability for | Capability for | adjusting |
| Bearing type | radial load | pushing load | misalignment |
| Single row deep | good | fair | fair |
| groove ball | | | |
| bearing | | | |
| Double row | excellent | good | fair |
| deep groove ball | | | |
| bearing | | | |
| Angular cintact | good | excellent | worse |
| Cylindrical | excellent | inferior | fair |
| roller | | | |
| Needle roller | excellent | worse | worse |
| Spherical roller | excellent | Fair/good | excellent |
| Tapered roller | excellent | excellent | good |

The invention uses a computer to send instructions that are transformed to signals through a D/A interface card for AC servo motors to drive circular blades and cylinders to carry out material removing and winding operations. The speeds of the two motors can only have a slight difference. If the difference is too large, the substrate will be pulled and dragged to be thereby deformed. This affects the precision in removing materials and the quality of the film. Along with the increased quantity of the winded films on the cylinder, the rotation speed of the motor needs adjustment. Besides, tangential velocity is equal to rotation radius times angular velocity (V=Rω). In order to have a constant speed in winding materials, the angular velocity of the motor should be adjusted with the increase of the rotation radius. By controlling parameters for one motor and also sending a feedback for the other motor, the speeds of the two motors are adjusted simultaneously. The control increases the rotating speed of the motors without destroying the substrates (without substrate deformation) so as to optimize the production speed to have better efficiency.

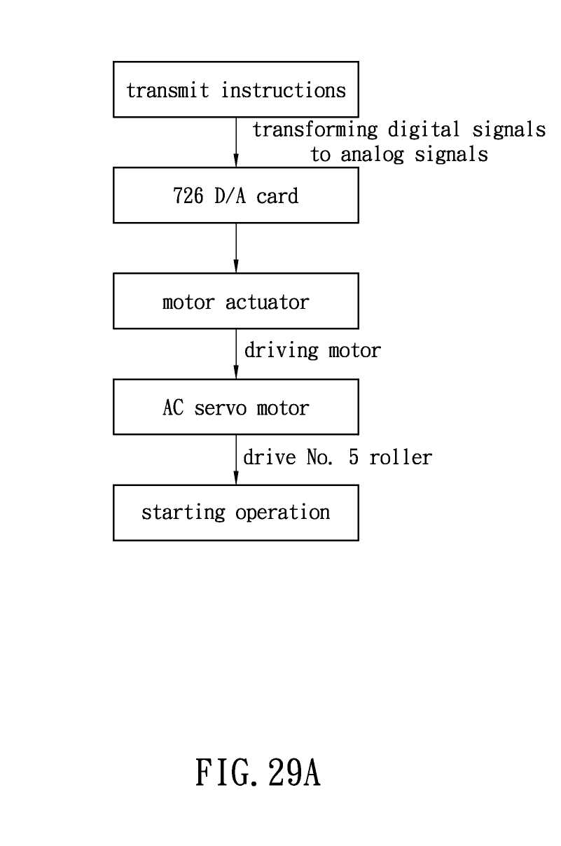

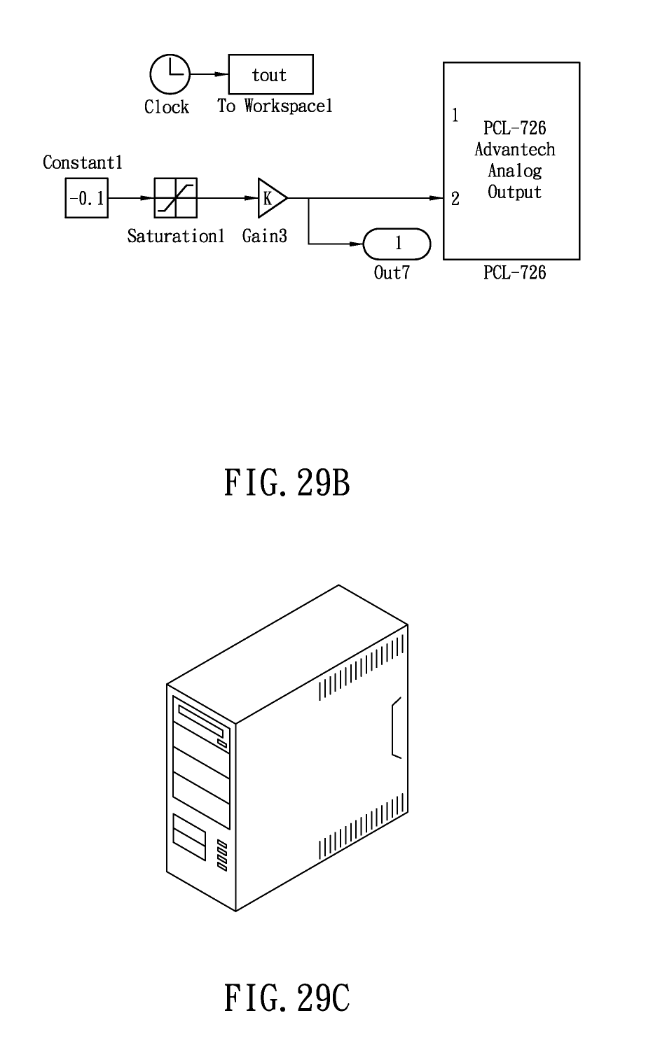

FIG. 29A is a schematic diagram illustrating a control flow chart according to the second embodiment of the present invention. As shown in FIG. 29A, at first a XPC computer sends programmed instructions. Next, a 726 D/A interface card transforms digital signals to analog signals (D/A converter). After sending the signals to the motor actuator, the motor starts. After the AC servo motors are driven by the motor actuator, the substrate is winded on the cylinder. FIG. 29B is a schematic diagram illustrating computer programming instructions according to the second embodiment of the present invention.

The above-described control system uses the following equipments:

### (A) XPC computer, as shown in FIG. 29C, implemented with a motor control system and sending instructions to a motor actuator through a 726 D/A card;

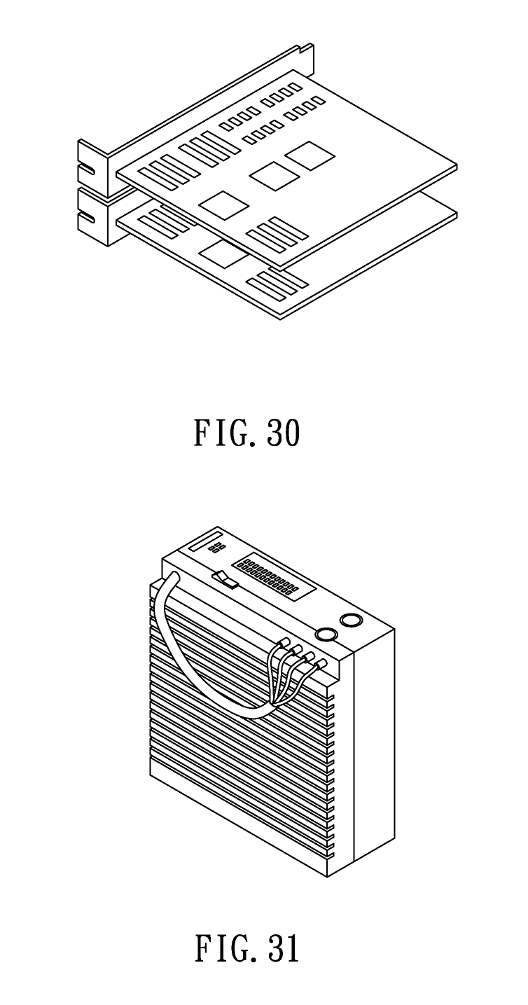

### (B) 726 D/A card, as shown in FIG. 30, transforming digital signals from a computer to analog signals;

### (C) motor actuator, as shown in FIG. 31, comprising parameters for controlling AC servo motors;

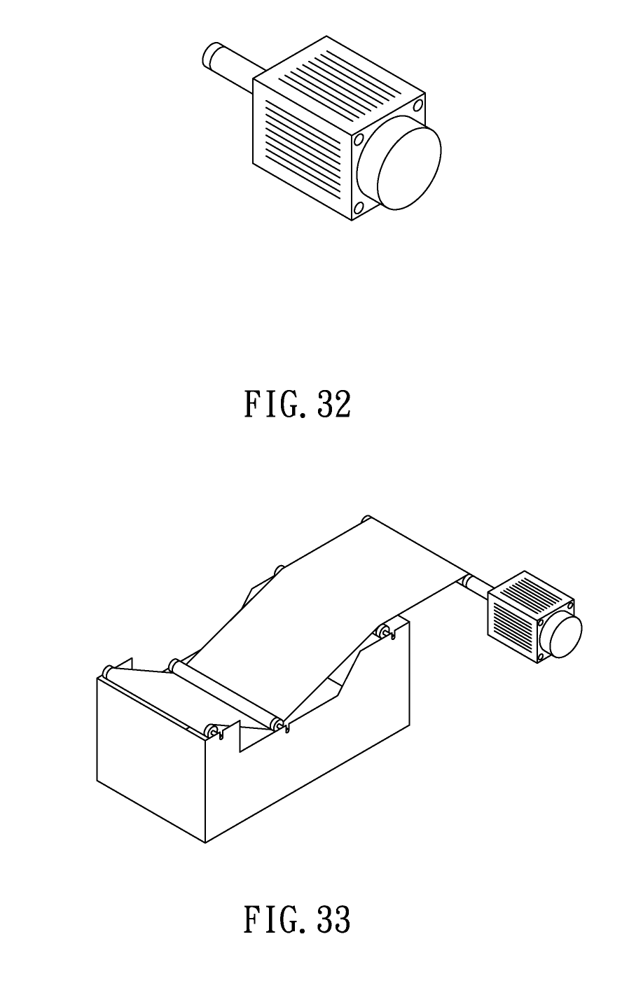

### (D) AC servo motor, as shown in FIG. 32, connected to a cylinder, directly drive the cylinder, and thus controlling the rotation speed of the cylinder.

In order to verify the control theory of using the tension control mechanism for maintaining the uniformity by the cylinders and motors, the following experiment is designed. FIG. 33 is a schematic diagram illustrating an experimental model according to the second embodiment of the present invention.

At first, plastic wrap is used as the substrate to carry out the tension control test through the pretension cylinder and tension control and driven by the AC servo motor for the substrate for various tests. The designed tension control mechanism can be proved by the experiment. Thus, after tested by the experimental model, the tension control and pretension design by the cylinder is satisfied.

From the experiment, it is found that the large torque generated by starting the motor deforms the substrate and the tension control mechanism improves the condition of the deformation of the substrate. While feeding the substrate and running the motor speed fast, the deformation of the substrate is clearly found. Therefore, the motor speed needs to be controlled. Thus, the design principle is proved to be reasonable from the experiment. However, the data from this experiment is not accurate for the motor speed and other micro-adjustment parts due to the experimental error. The detail data needs to be proceeded by further testing.

Obviously many modifications and variations are possible in light of the above teachings. It is therefore to be understood that within the scope of the appended claims the present invention can be practiced otherwise than as specifically described herein. Although specific embodiments have been illustrated and described herein, it is obvious to those skilled in the art that many modifications of the present invention may be made without departing from what is intended to be limited solely by the appended claims.

What is claimed is:

1. An apparatus for film formation, comprising:
a fluid auto-injecting mechanism for injecting a viscous fluid material on a substrate and controlling said fluid material wherein said fluid material is capable of filtering out volatile organic compounds and said substrate has a shape and a tension;
a tension control mechanism for controlling the tension of said substrate to prevent from shape deformation; and
a scraper with a height for uniformly scraping said fluid material wherein the height of said scraper is adjustable.

2. The apparatus according to claim 1, wherein the material of said scraper is capable of preventing said substrate from being scratched.

3. The apparatus according to claim 1, wherein said scraper comprises an elastic rubber scraping board.

4. The apparatus according to claim 1, further comprising: a material auto-feeding system for automatically changing said substrate.

5. The apparatus according to claim 1, further comprising: an oven for heating said fluid material.

6. An apparatus for film formation, comprising:
a substrate auto-feeding system for automatically changing said substrate wherein said substrate has a shape and a tension;
a fluid auto-injecting mechanism for injecting a viscous fluid material on a substrate and controlling said fluid material wherein said fluid material is capable of filtering out volatile organic compounds and said substrate has a shape and a tension;
a tension control mechanism for controlling the tension of said substrate to prevent from shape deformation;
a scraper with a height for uniformly scraping said fluid material wherein the height of said scraper is adjustable;
an oven for heating said fluid material; and,
a material removing module for removing the part of said substrate that is not coated with said fluid material.

7. The apparatus according to claim 6, further comprising: two linear slide rails for mounting said scraper.

8. The apparatus according to claim 6, wherein the material of said scraper is capable of preventing said substrate from being scratched.

9. The apparatus according to claim 6, wherein said scraper comprises an elastic rubber scraping board.

10. A method for film formation, comprising:
injecting a viscous fluid material on a substrate wherein said fluid material is capable of filtering out volatile organic compounds and said substrate has a shape and a tension;
controlling the tension of said substrate to prevent from shape deformation;
uniformly scraping said fluid material by a scraper with a adjustable height.

11. The method according to claim 10, wherein the height of said scraper is adjusted by two parallel linear slide rails mounting said scraper.

12. The method according to claim 10, wherein the material of said scraper is capable of preventing said substrate from being scratched.

13. The method according to claim 10, wherein said scraper comprises an elastic rubber scraping board.
